(19) United States
(12) Patent Application Publication
(10) Pub. No.: US 2005/0114473 A1
(43) Pub. Date: May 26, 2005

(54) FPGA boot-up over a network

(76) Inventors: Ravid Guy, Petah-Tikva (IL); Erez Aharon-Yariv, Rehovot (IL); Eran Shpak, Tel Aviv (IL)

Correspondence Address: Abelman, Frayne & Schwab, 150 East 42nd Street, New York, NY, 10017, US

(21) Appl. No.: 10/699,254

(22) Filed: Oct. 30, 2003

(51) Int. Cl. G06F 15/177

(52) U.S. Cl. 709/220

(57) ABSTRACT

Network node apparatus includes a physical layer interface (PHY) device, which includes a network port and a data output port. A field-programmable logic device includes a configuration port, which is coupled to the data output port of the PHY device so as to receive program code, which is transmitted over the network during a programming phase in order to program the field-programmable logic device. The logic device also includes a data input port, which is likewise coupled to the data output port of the PHY device so as to receive communication data transmitted over the network following conclusion of the programming phase, whereupon the field programmable logic device is programmed by the program code to process the communication data in accordance with a predetermined data link layer protocol.

### FIELD OF THE INVENTION

The present invention relates generally to network communication devices, and specifically to low-cost node devices for use in local area networks, including wireless local area networks.

### BACKGROUND OF THE INVENTION

Installation of a wireless local area network (WLAN) in a facility generally requires that wireless access points be deployed at appropriate locations throughout the service region of the WLAN. The access points are typically connected to a network hub by a wired LAN, typically an Ethernet LAN. This LAN serves as a distribution system medium (DSM) for carrying data to and from mobile stations that are served by the WLAN. It permits the mobile stations to send and receive data to and from external networks, via the access points and the hub.

In a typical WLAN, each access point comprises a radio transceiver for communicating with the mobile stations, and a LAN interface for communicating over the wired LAN. A processor performs higher-level functions, such as medium access control (MAC) protocol processing, as required for communication over both the wireless and the wired networks to which the access point is connected. Typically, the processor comprises a programmable device, such as a microprocessor or a field-programmable logic device. The program code (software or firmware) for the programmable device is stored in non-volatile memory in the access point. When the access point is turned on, the programmable device boots from the code stored in the non-volatile memory and is then ready to operate.

### SUMMARY OF THE INVENTION

Embodiments of the present invention provide a programmable WLAN access point that requires substantially no on-board non-volatile program memory. The access point comprises a field-programmable logic device, such as a field-programmable gate array (FPGA), with a radio transceiver and LAN interface as described above. When the access point starts up (typically at power-up or reset of the WLAN), program code is downloaded to the access point over the LAN, and is loaded directly via the LAN interface into the FPGA. Once the code is loaded, the FPGA is ready to perform its communication functions in the WLAN.

This novel access point has several advantages over network devices known in the art:
Reduced cost and component count.
Ease of upgrades and maintenance—Program code is stored centrally on a server, from which it is downloaded to the access points via the LAN. Thus, the code can also be upgraded centrally, and upgrades are automatically propagated to the access points upon system reset.
License control—Any software license that is required for the access points is held and controlled centrally on the server.

Although the embodiments of the present invention that are described herein relate specifically to WLAN access points, the principles of the present invention are also applicable to other types of network node devices.

There is therefore provided, in accordance with an embodiment of the present invention, network node apparatus, including:
a physical layer interface (PHY) device, which includes a network port and a data output port, and is adapted to receive signals from a communication network through the network port and to process the signals in accordance with a predetermined physical layer protocol so as to generate a digital data output at the data output port; and
a field-programmable logic device, including:
   a configuration port, which is coupled to the data output port of the PHY device so as to receive program code, which is transmitted over the network during a programming phase in order to program the field-programmable logic device; and
   a data input port, which is also coupled to the data output port of the PHY device so as to receive communication data transmitted over the network following conclusion of the programming phase, whereupon the field programmable logic device is programmed by the program code to process the communication data in accordance with a predetermined data link layer protocol.

Typically, the apparatus includes substantially no non-volatile memory for holding the program code. The configuration port and data input port may be connected in parallel to the data output port substantially without other logic components intervening between the ports.

In some embodiments, the physical layer protocol and data link layer protocol include Ethernet protocols. Typically, the PHY device is adapted to generate the digital data output in accordance with an Ethernet media independent interface (MII).

In a disclosed embodiment, during the programming phase, the digital data output includes a sequence of clock bits, which are generated by the PHY device responsively to the signals received from the communication network, and the field programmable logic device includes a clock input, which is coupled to receive the clock bits so as to clock the program code into the input port.

Typically, the field programmable logic device further includes a data transmit port and is further programmed by the program code to generate data frames at the data transmit port in accordance with the data link protocol, and the PHY device includes a data receive port, which is coupled to the data transmit port so as to receive the data frames generated by the field programmable logic device for transmission over the communication network via the network port.

In a disclosed embodiment, the apparatus includes a radio transceiver, which is coupled to the field programmable logic device so as to transmit the processed communication data over the air to a mobile station in a wireless local area network (WLAN).

Typically, the field programmable logic device includes a field programmable gate array (FPGA).

Optionally, the apparatus includes an identification (ID) component holding an identification value and coupled to be read by the field programmable logic device, so that when the field programmable logic device is programmed by the program code, the field programmable logic device conveys the identification value over the network to a code server.

There is also provided, in accordance with an embodiment of the present invention, an access point for use in a wireless local area network (WLAN) including substantially no non-volatile program memory. Typically, the access point includes:
a radio transceiver, for exchanging communication signals over the air with a mobile station in the WLAN;
a physical layer interface (PHY) device, for communicating with one or more network nodes over a wired local area network (LAN); and
a programmable medium access control (MAC) processor, coupled between the radio transceiver and the PHY device, so as to receive program code over the LAN via the PHY device and, responsively to the program code, to perform MAC-level processing of the communication signals.

In some embodiments, the LAN is an Ethernet LAN, and the MAC processor is adapted, responsively to the program code, to perform the MAC-level processing in accordance with an Ethernet protocol. Typically, the programmable MAC processor includes a field programmable gate array (FPGA).

There is additionally provided, in accordance with an embodiment of the present invention, apparatus for communication over a network, which operates in accordance with a predetermined physical layer protocol, the apparatus including:
a code server, which is adapted to transmit program code over the network during a programming phase of the apparatus; and
a network node, including:
   a physical layer interface (PHY) device, which includes a network port and a data output port, and is adapted to receive signals from the network through the network port and to process the signals in accordance with the physical layer protocol so as to generate a digital data output at the data output port; and
   a field-programmable logic device, including a configuration port, which is coupled to the data output port of the PHY device so as to receive the program code transmitted by the code server in order to program the field-programmable logic device, and including a data input port, which is also coupled to the data output port of the PHY device so as to receive communication data transmitted over the network following conclusion of the programming phase, whereupon the field programmable logic device is programmed by the program code to process the communication data in accordance with a predetermined data link layer protocol.

Typically, the code server is adapted to frame the program code in data frames in accordance with the physical layer protocol, so as to cause the PHY device to output the program code through the data output port in a format suitable for programming the field programmable logic device. In a disclosed embodiment, the code server is adapted to incorporate in the data frames, together with the program code, a sequence of clock bits, and the field programmable logic device includes a clock input, which is coupled to receive the clock bits from the PHY device so as to clock the program code into the configuration port.

In one embodiment, the network node includes an identification (ID) component holding an identification value and coupled to be read by the field programmable logic device, so that when the field programmable logic device is programmed by the program code, the network node conveys the identification value over the network to the code server. Typically, the program code includes start-up program code and operational program code, wherein code server is adapted to initially transmit the start-up program code to the network node, causing the network node to convey the identification value over the network to the code server, and the code server is further adapted, upon receiving the identification value, to select the operational program code to transmit to the network node responsively to the identification value.

There is further provided, in accordance with an embodiment of the present invention, apparatus for use in a wireless local area network (WLAN), including:
a code server, which is adapted to transmit program code over a distribution system medium (DSM) during a programming phase of the apparatus; and
one or more access points, each including:
   a radio transceiver, for exchanging communication signals over the air with a mobile station served by the WLAN;
   a physical layer interface (PHY) device, for communicating over the DSM; and
   a programmable medium access control (MAC) processor, coupled between the radio transceiver and the PHY device, so as to receive the program code over the DSM via the PHY device and, responsively to the program code, to perform MAC-level processing of the communication signals.

In disclosed embodiments, the DSM includes an Ethernet LAN, and wherein the MAC processor is adapted, responsively to the program code, to perform the MAC-level processing in accordance with an Ethernet protocol. Typically, the programmable MAC processor includes a field programmable gate array (FPGA), and the access points include substantially no non-volatile memory for storing the program code.

There is moreover provided, in accordance with an embodiment of the present invention, a method for network communication, including:
coupling a node, which includes a programmable processor, to receive signals from a communication network;
processing the signals at the node in accordance with a predetermined physical layer protocol so as to generate a digital data output;
transmitting the signals on the network in accordance with the physical layer protocol during a programming phase of the network so as to convey program code to the node;
coupling the digital data output to a configuration port of the programmable processor, so as to program the processor using the transmitted program code;
following conclusion of the programming phase, transmitting the signals on the network in accordance the physical layer protocol and with a predetermined data link layer protocol so as to convey communication data over the network to the node; and
coupling the digital data output to a data input port of the programmable processor, so that following the conclusion of the programming phase, the processor processes the communication data, responsively to the program code, in accordance with the data link layer protocol.

In some embodiments, the node includes a radio transceiver, and wherein the program code further causes the programmable processor to frame the processed communication data for transmission via the radio transceiver over the air to a mobile station in a wireless local area network (WLAN).

The present invention will be more fully understood from the following detailed description of the embodiments thereof, taken together with the drawings in which:

### BRIEF DESCRIPTION OF THE DRAWINGS

FIG. 1 is a block diagram that schematically illustrates a wireless local area network (WLAN) system, in accordance with an embodiment of the present invention;

FIG. 2 is a block diagram that schematically shows details of a hub and access point in a WLAN, in accordance with an embodiment of the present invention;

FIGS. 3A-3C are schematic electrical circuit diagrams showing circuitry used in an access point, in accordance with an embodiment of the present invention; and

FIG. 4 is a schematic timing diagram showing signals used in programming an access point, in accordance with an embodiment of the present invention.

### DETAILED DESCRIPTION OF EMBODIMENTS

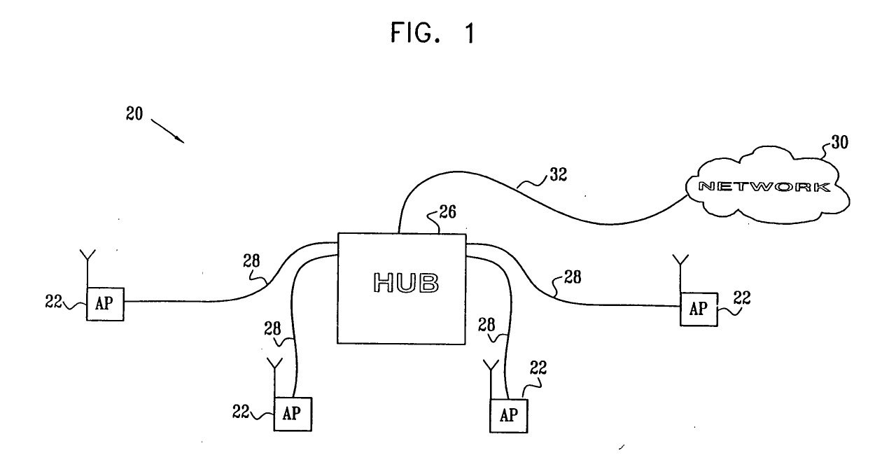

FIG. 1 is a block diagram that schematically illustrates a wireless LAN (WLAN) system 20, in accordance with a preferred embodiment of the present invention. System 20 comprises multiple access points 22, which are configured for data communication with mobile stations (not shown). In an exemplary embodiment, the access points and mobile stations communicate with one another in accordance with one of the standards in the IEEE 802.11 family. Alternatively, the principles of the present invention may be applied in substantially any type of WLAN, including HiperLAN, Bluetooth and hiswan-based systems.

Access points 22 are connected by a communication medium, typically comprising a wired LAN 28, with a hub 26. In the embodiment described below, LAN 28 is an Ethernet LAN, operating in accordance with the IEEE 802.3 standard. LAN 28 serves as the distribution system medium (DSM) for exchanging data between the access points and the hub. Hub 26 connects the access points to an external network 30, such as the Internet, via an access line 32, so as to enable mobile stations to send and receive data through access points 22 to and from the external network.

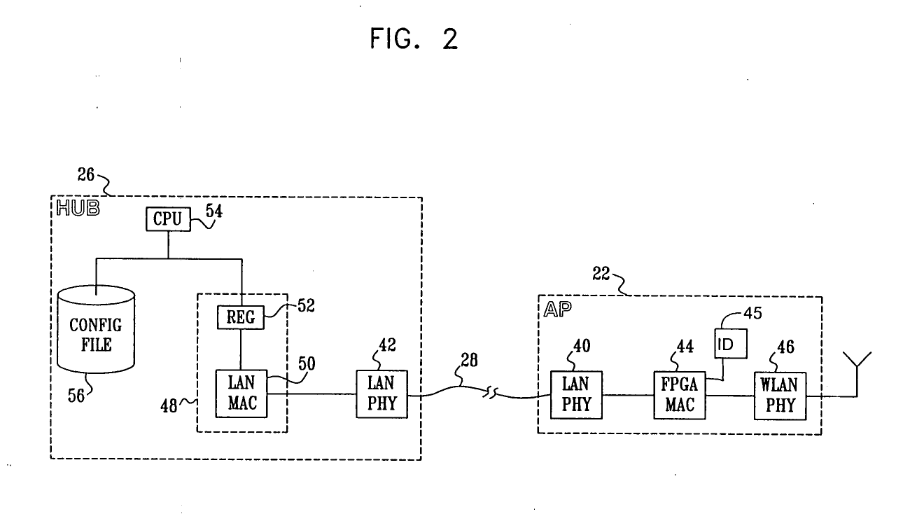

FIG. 2 is a block diagram that schematically shows details of hub 26 and of one of access points 22, in accordance with an embodiment of the present invention. The access point and the hub comprise respective physical layer interface (PHY) devices 40 and 42, which provide the physical link over LAN 28 between the access point and hub. PHY device 40 receives analog signals over the LAN, as specified by the 802.3 standard, and converts the signals to frames of digital output data.

A MAC processor 44 performs data link layer (OSI Layer 2) protocol processing functions on the output data from PHY device 40. These functions include, for example, processing of the frame headers and error detection (CRC) codes, as is known in the art. Similarly, the MAC processor generates data frames, which are converted by PHY device 40 to analog signals for transmission over the LAN to hub 26. Processor 44 is implemented as a field-programmable gate array (FPGA), which is programmed to carry out these protocol processing functions by means of signals transmitted from hub 26 over LAN 28, as described in detail hereinbelow. In this embodiment, processor 44 is also programmed to interact with a WLAN PHY device 46, comprising a radio transceiver for communicating with mobile stations over the appropriate WLAN frequency channels. Optionally, access point 22 comprises an identification (ID) component 45, coupled to processor 44, for purposes described hereinbelow.

Hub 26 communicates over LAN 28 via its own access point interface 48, which is coupled to the LAN through PHY device 42. Interface 48, like processor 44, may be implemented as a FPGA. Alternatively, other implementations will be apparent to those skilled in the art. Interface 48 comprises a MAC processor 50 and a control register 52. During normal operation of system 20, processor 50 transmits and receives data frames over the LAN to and from access point 22. Processor 50 is also responsible for transmitting program code via PHY device 42 over LAN 28 during a programming phase at startup or reset of system 20, in order to program processor 44 prior to beginning normal operation.

The program code that is downloaded to access point 22 in the programming phase is held in a configuration file in a memory 56 of hub 26. Typically, memory 56 comprises a disk or other non-volatile storage media. At startup or reset of system 20, a central processing unit (CPU) 54 reads the configuration file from memory 56, and outputs the program code from the configuration file to interface 48 by writing successive words of the code to register 52. Processor 50 converts the code words to an appropriate binary form for transmission over the LAN via PHY device 42, as described hereinbelow.

Although hub 26 is shown, for the sake of simplicity, as comprising only a single interface 48, typically the hub comprises multiple interfaces of this sort, with one interface (and a corresponding PHY device 42) coupled to communicate with each access point 22 in system 20. CPU 54 may be connected to memory 56 and to interfaces 48 by an internal bus in hub 26, such as a Peripheral Component Interface (PCI) bus, as is known in the art. In this case, register 52 in each interface 48 has its own PCI bus address, and CPU 54 uses PCI bus operations to write all the words of the access point program code to the registers in each of the access point interfaces. Hub 26 thus functions as a code server, which programs access points 22 during the programming phase at system startup or reset. Alternatively, the code server function described herein may be performed by an external computer, which is suitably linked to hub 26 or to another node on LAN 28.

CPU 54 typically comprises a general-purpose microprocessor, which carries out its code serving functions (as well as other communication functions, which are beyond the scope of the present invention) under the control of software. The operating software for CPU 54 may be stored, along with the configuration file, in memory 56. This software may be downloaded to the CPU in electronic form, over network 30 (FIG. 1), for example, or it may alternatively be provided on tangible media, such as CD-ROM or non-volatile magnetic or electronic memory.

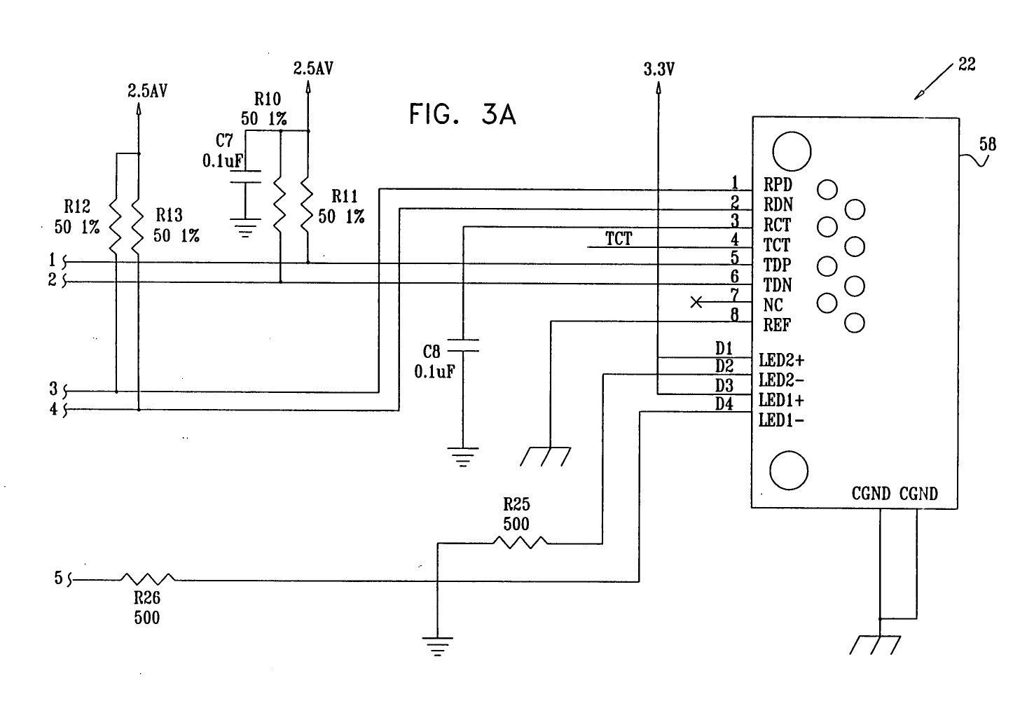

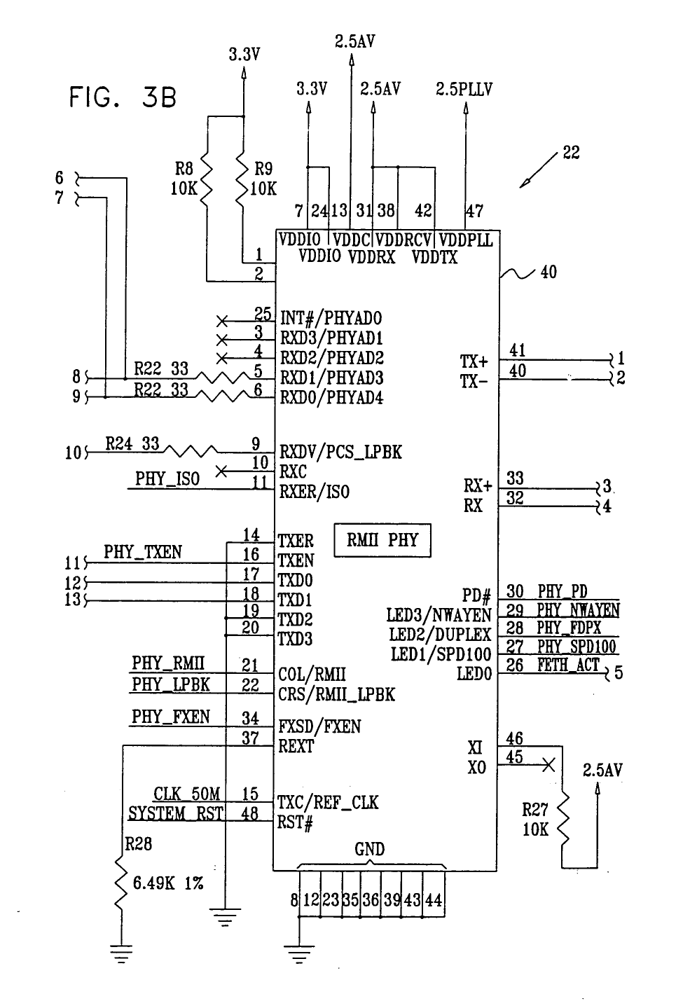

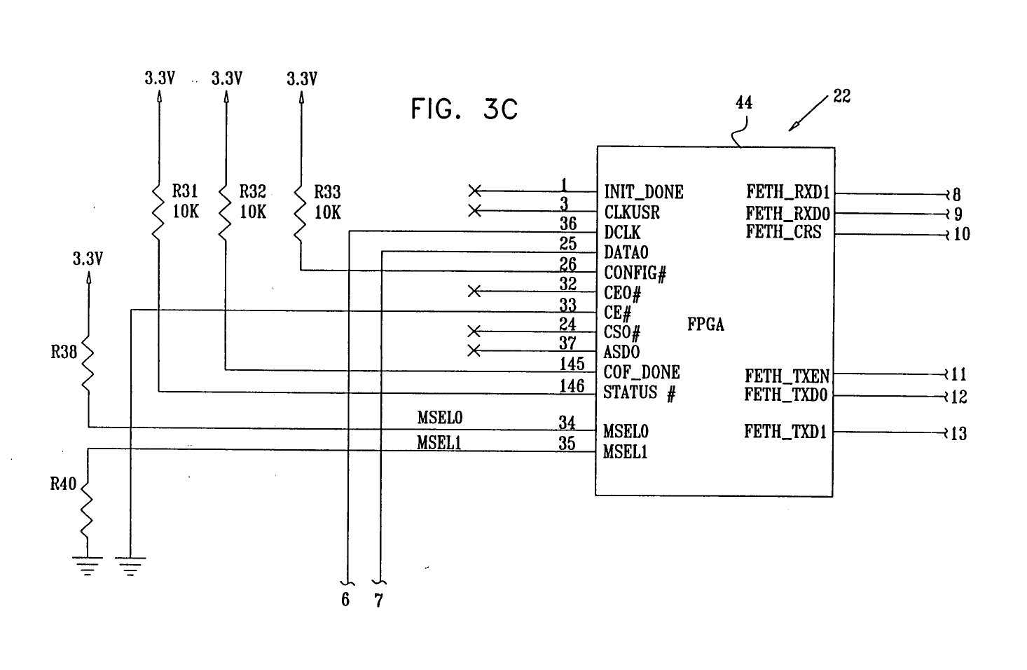

FIGS. 3A, B and C are schematic electrical circuit diagrams showing elements of access point 22, in accordance with an embodiment of the present invention. In this embodiment, LAN 28 is configured as a 100BASE-T Ethernet LAN, running over CAT-5 cable and operating in accordance with the IEEE 802.3 PHY standard. PHY devices 40 and 42 are configured for data output and input to and from MAC processors 44 and 50 in accordance with the Reduced Media Independent Interface (RMII) specification provided by the 802.3 standard. This detailed implementation is shown here only by way of example, however, and it will be understood that access points 22 may similarly be implemented on the basis of other LAN types and specifications.

A standard RJ45 connector 58 links access point 22 to LAN 28. For example, connector 58 may comprise a RJ767-CL1 device, made by TransPower Technologies Inc. (Reno, Nev.), which also includes a suitable transformer for inductive coupling to the LAN. The transmit (TX) and receive (RX) circuits of the LAN are coupled by connector 58 to the TX and RX network ports (pins 40/41 and 43/44) of PHY device 40. In the present embodiment, device 40 comprises a KS8721B Physical Layer Transceiver, made by Micrel-Kendin (Sunnyvale, Calif.). The transceiver is configured for RMII input/output, as noted above. In this configuration, device 40 outputs data via a data output port (RXD1 and RXD0—pins 5 and 6) to processor 44, and receives input data from the processor via a data input port (TXD0 and TXD1—pins 17 and 18). A local oscillator and reset generator (not shown) are connected to pins 15 and 48 of device 40, as specified by the device manufacturer. Further information regarding connector 58 and device 40 is available from the respective manufacturers.

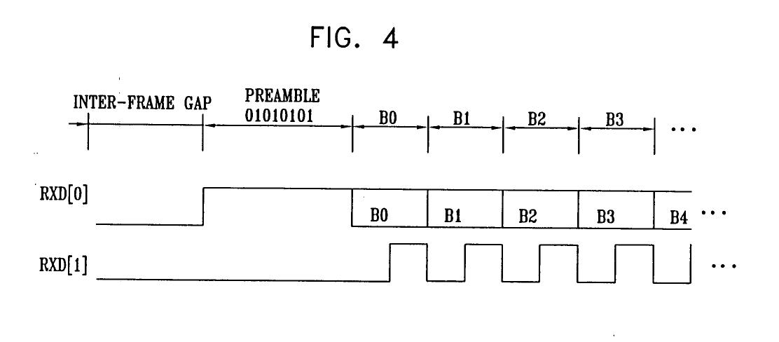

Processor 44 comprises a Cyclone™ EP1C6 FPGA chip, produced by Altera Corp. (San Jose, Calif.). To enable programming of the FPGA by CPU 54, the FPGA chip is configured in “passive serial” mode, by setting MSEL1 (pin 35) low, and setting MSEL0 (pin 34) high, as shown in FIG. 3C. Programming of processor 44 may begin immediately upon power-up. The chip is then programmed by applying binary program data to a configuration port (DATA0—pin 25) while driving DCLK (pin 36) with a suitable clock. The chip receives successive bits of program data via DATA0 on the rising edge of the clock on DCLK, and applies these bits to set successive gates in the FPGA, according to a predetermined sequence specified by the manufacturer. The DATA0 and DCLK pins of the FPGA chip are connected to the RXD1 and RXD0 output pins of PHY device 40, and thus receive the program data sent over LAN 28 from hub 26 during the programming phase. The data coding protocol that is used for this purpose is described further hereinbelow with reference to FIG. 4.

Programming of processor 44 is complete once DCLK has received a predetermined number of clock cycles (exactly 1,167,216 clock cycles for the above-mentioned EP1C6 device). Processor 44 automatically sets its INIT_DONE output (pin 1), indicating that all the gates in processor 44 are set. At this point, the operational phase of communications on LAN 28 can begin. In the program that is loaded into processor 44, two of the input/output (I/O) pins of the FPGA chip—marked FETH_RXD0 and FETH_RXD1—are assigned to serve as a data input port. These pins are connected to receive data from RXD0 and RXD1 of PHY device 40, in the RMII format, in parallel with the above-mentioned configuration pins (DCLK and DATA0). Data frames transmitted over LAN 28 from hub 26 are transferred via RXD0 and RXD1 to processor 44 for MAC-level protocol processing, in accordance with the program.

Two additional I/O pins of processor 44—FETH_TXD0 and FETH_TXD1—are assigned to serve as a data output port. These pins are connected to output data frames generated by processor 44 to TXD0 and TXD1 of PHY device 40 for transmission over LAN 28. The RXDV output (pin 9) of PHY device 40 is connected to an another I/O pin of processor 44 that is assigned to the FETH_CRS (carrier sense output) function, while the TXEN input (pin 16) of device 40 is connected to the FETH_TXEN (input transmit enable) I/O pin of processor 44. The operation of these pins are defined by the RMII specification of the 802.3 standard.

The appropriate choice of I/O pins of processor 44 to be connected to PHY devices 40 and 46 will be apparent to those skilled in the art, as will the details of the program code that is loaded into processor 44 via PHY device 40. Other I/O pins of processor 44 are connected to the appropriate input and output pins of WLAN PHY device 46 and perform similar data input and output functions. Further information regarding programming of the Cyclone FPGA chip, including the use of pins shown in FIG. 3C but not described hereinabove, is available from Altera. Although the present embodiment relates specifically to this FPGA chip, other field-programmable logic devices may likewise be used, mutatis mutandis, to perform the functions processor 44.

FIG. 4 is a timing diagram that schematically illustrates signals generated by PHY device 40 for programming processor 44, in accordance with an embodiment of the present invention. Referring to the embodiment shown in FIGS. 3B and 3C, these signals are generated at the RXD0 and RXD1 output pins of device 40, for input to the DATA0 and DCLK pins of processor 44, respectively. As shown in FIG. 4, a sequence of bits B0, B1, B2, . . . , is clocked into DATA0 by the clock waveform on DCLK, wherein each bit is input to DATA0 on the rising edge of the corresponding clock pulse.

To generate the signals shown in FIG. 4, CPU 54 (FIG. 2) reads binary data (B0, B2, B2, . . . ) from the configuration file in memory 56. The CPU then frames the data in bytes, with two data bits per byte, as follows (with the most significant bit at the left):
{1, B1, 0, B1, 1, B0, 0, B0} (1)
CPU 54 writes the framed data in 32-bit chunks (each containing eight bits of the actual binary program data) to register 52. Processor 50 reads out the contents of the register and then transfers the contents via RMII to PHY device 42. Alternatively, CPU 54 may write the binary program data (B0, B1, B2, . . . ) to register 52, and processor 50 may frame the data as shown by example (1) above.

In accordance with the RMII specification, processor 50 transfers the data to PHY device 42 two bits at a time, going from the least significant to the most significant bit pair in each byte. PHY device 42 transmits the data over LAN 28 in frames that comply with the Ethernet physical layer standard. Therefore, as shown in FIG. 4, each frame begins after the conventional inter-frame gap with the standard Ethernet preamble, “01010101.” Note, however, that the frames containing the program data during the programming phase of system 20 do not comply with the Ethernet MAC layer standard. Processor 50 is programmed to handle these special program frames differently from its handling of the standard Ethernet frames that are transmitted over LAN 28 in normal operation.

PHY device 40 receives the frames from LAN 28 and reads out the frame data via its data output port to processor 44. In accordance with the RMII specification, the bits are transferred out of device 40 in pairs on outputs RXD1 and RXD0, beginning from the least significant bit pair in each successive byte. Taking example (1) above as input, the output on {RXD1, RXD0} will be {0, B0}, {1, B0}, {0, B1}, {1, B1}, giving the signal pattern shown in FIG. 4. Thus, the DCLK input of processor 44 receives the clock input sequence {0, 1, 0, 1}, while the DATA0 program input receives (B0, B0, B1, B1}. (During the preamble, RXD0 is forced to the value 1 by device 40, while RXD1 is 0, so that programming does not begin until the next byte after the preamble.) In this manner, the FPGA chip that serves as processor 44 is programmed directly from the RMII output of device 40 without the need for any intervening logic.

Whereas the exemplary embodiment described above makes use of the Ethernet RMII, other interface definitions may similarly be used between PHY device 40 and processor 44. Some interfaces, such as the Ethernet MII, can be used, like RMII, to program processor 44 without additional logic. Other interface definitions, however, such as the serial media independent interface (SMII), may require some simple adaptation logic to connect the PHY device output to the FPGA input.

In some embodiments of the present invention, ID component 45 is coupled to one or more of the I/O pins of processor 44 for use in programming of the processor. Component 45 may be used, for instance, to indicate the type of WLAN PHY device 46 that is used in access point 22, or to distinguish between different release versions of the access point. Component 45 may simply comprise a resistor, for example, whose value is indicative of the access point identification. Alternatively, component 45 may comprise a hard-programmed logic or memory device, or any other suitable type of identification component that is known in the art. In this case, component 45 may hold additional identifying information, besides just the type or release version. To the extent that component 45 comprises a memory device, this device could possibly be used to hold some program code for the access point. In embodiments of the present invention, however, all program code is preferably stored centrally, and not in the access points. Therefore, the access points still contain substantially no non-volatile program memory, notwithstanding the use of a memory device as ID component 45.

Upon power-up or reset of access point 22, hub 26 downloads generic, start-up program code to processor 44, in the manner described above. The purpose of this start-up code is to cause the processor to read the value of component 45, and to report the value back via LAN 28 to hub 26. Based on this value, CPU 54 determines the version of operational program code to be downloaded subsequently to this particular access point.

In order to reprogram processor 44 with the operational program code, when the processor comprises an FPGA device such as the above-mentioned Altera Cyclone, it is necessary to reset the access point. Such a reset can be accomplished in a number of ways. For instance, access point 22 may be configured to receive electrical power over LAN 28, as specified by the IEEE 802.3af standard. (An exemplary implementation of an access point that receives DC power over LAN is described in U.S. patent application Ser. No. 10/321,879, filed Dec. 17, 2002, which is assigned to the assignee of the present patent application and whose disclosure is incorporated herein by reference.) In this case, hub 26 typically comprises power control circuitry (not shown), which may be operated to switch power to access point 22 off briefly and then back on in order to perform the desired reset. Alternatively, one of the I/O pins of processor 44 may be connected to the system reset or configuration pin, and may be used to perform a self-reset of the processor after the ID component value has been conveyed to hub 26.

Automatic programming of processor 44 may occur not only when system 20 is initially switched on or reset, but also when a new access point 22 is connected to the system during operation. Some Ethernet PHY devices are capable of automatic link detection. If LAN PHY device 42 of hub 26 has this capability, MAC processor 50 will receive the link detection signal from device 42 when an access point is initially connected to one of the hub ports. For example, when SMII is used, link information is conveyed by the LAN PHY device to the MAC processor using predefined data bits during the inter-frame gap interval. When other types of MII are used, the PHY device typically has link pins that may be connected to appropriate pins of the MAC processor for purposes of link detection. In any case, when MAC processor 50 receives a link detection signal, it notifies CPU 54, which then downloads the appropriate program code to the new access point, as described above.

Alternatively, CPU 54 may prompt MAC processor 50 periodically to download the start-up program code to all unconfigured hub ports, i.e., to any ports that have not yet received the operational access point program code. If a new access point is present on any of the unconfigured ports, the start-up program code will program processor 44 in the new access point to read and return the value of its ID component 45. Upon receiving the ID value, CPU 54 will proceed to download the operational program code to the new access point, as described above, and will remove it from the unconfigured list.

Although the embodiments described above relate to programming and operation of wireless access points, the methods described above may likewise be applied to network node devices of other types. For example, these methods may be used to configure and control automatic device testing and debugging from a central hub via a LAN. In such systems, a unit under test (such as an electronics board under development) is typically plugged into a test jig, which includes a FPGA containing code for emulating the system in which the unit is to be used or otherwise providing test signals to the unit. The present invention may used to enable flexible reprogramming of the FPGA over a network and to allow several test jigs of this sort to be operated in parallel from a central test station.

Furthermore, although these embodiments are based on an Ethernet LAN and take advantage of certain features of Ethernet media independent interfaces, the principles of the present invention may similarly be used to program network node devices over networks of other types.

It will thus be appreciated that the embodiments described above are cited by way of example, and that the present invention is not limited to what has been particularly shown and described hereinabove. Rather, the scope of the present invention includes both combinations and subcombinations of the various features described hereinabove, as well as variations and modifications thereof which would occur to persons skilled in the art upon reading the foregoing description and which are not disclosed in the prior art.

1. Network node apparatus, comprising:
a physical layer interface (PHY) device, which comprises a network port and a data output port, and is adapted to receive signals from a communication network through the network port and to process the signals in accordance with a predetermined physical layer protocol so as to generate a digital data output at the data output port; and
a field-programmable logic device, comprising:
a configuration port, which is coupled to the data output port of the PHY device so as to receive program code, which is transmitted over the network during a programming phase in order to program the field-programmable logic device; and
a data input port, which is also coupled to the data output port of the PHY device so as to receive communication data transmitted over the network following conclusion of the programming phase, whereupon the field programmable logic device is programmed by the program code to process the communication data in accordance with a predetermined data link layer protocol.

2. The apparatus according to claim 1, wherein the apparatus comprises substantially no non-volatile memory for holding the program code.

3. The apparatus according to claim 1, wherein the configuration port and data input port are connected in parallel to the data output port substantially without other logic components intervening between the ports.

4. The apparatus according to claim 1, wherein the physical layer protocol and data link layer protocol comprise Ethernet protocols.

5. The apparatus according to claim 4, wherein the PHY device is adapted to generate the digital data output in accordance with an Ethernet media independent interface (MII).

6. The apparatus according to claim 1, wherein during the programming phase, the digital data output comprises a sequence of clock bits, which are generated by the PHY device responsively to the signals received from the communication network, and wherein the field programmable logic device comprises a clock input, which is coupled to receive the clock bits so as to clock the program code into the input port.

7. The apparatus according to claim 1, wherein the field programmable logic device further comprises a data transmit port and is further programmed by the program code to generate data frames at the data transmit port in accordance with the data link protocol, and
wherein the PHY device comprises a data receive port, which is coupled to the data transmit port so as to receive the data frames generated by the field programmable logic device for transmission over the communication network via the network port.

8. The apparatus according to claim 1, wherein the field programmable logic device comprises a field programmable gate array (FPGA).

9. The apparatus according to claim 1, and comprising an identification (ID) component holding an identification value and coupled to be read by the field programmable logic device, so that when the field programmable logic device is programmed by the program code, the field programmable logic device conveys the identification value over the network to a code server.

10. Apparatus for communication over a network, which operates in accordance with a predetermined physical layer protocol, the apparatus comprising:
a code server, which is adapted to transmit program code over the network during a programming phase of the apparatus; and
a network node, comprising:
a physical layer interface (PHY) device, which comprises a network port and a data output port, and is adapted to receive signals from the network through the network port and to process the signals in accordance with the physical layer protocol so as to generate a digital data output at the data output port; and
a field-programmable logic device, comprising a configuration port, which is coupled to the data output port of the PHY device so as to receive the program code transmitted by the code server in order to program the field-programmable logic device, and comprising a data input port, which is also coupled to the data output port of the PHY device so as to receive communication data transmitted over the network following conclusion of the programming phase, whereupon the field programmable logic device is programmed by the program code to process the communication data in accordance with a predetermined data link layer protocol.

11. The apparatus according to claim 10, wherein the network node comprises substantially no non-volatile memory for holding the program code.

12. The apparatus according to claim 10, wherein the configuration port and data input port are connected in parallel to the data output port substantially without other logic components intervening between the ports.

13. The apparatus according to claim 10, wherein the physical layer protocol and data link layer protocol comprise Ethernet protocols.

14. The apparatus according to claim 10, wherein the code server is adapted to frame the program code in data frames in accordance with the physical layer protocol, so as to cause the PHY device to output the program code through the data output port in a format suitable for programming the field programmable logic device.

15. The apparatus according to claim 14, wherein the code server is adapted to incorporate in the data frames, together with the program code, a sequence of clock bits, and wherein the field programmable logic device comprises a clock input, which is coupled to receive the clock bits from the PHY device so as to clock the program code into the configuration port.

16. The apparatus according to claim 10, wherein the field programmable logic device further comprises a data transmit port and is further programmed by the program code to generate data frames at the data transmit port in accordance with the data link protocol, and
wherein the PHY device comprises a data receive port, which is coupled to the data transmit port so as to receive the data frames generated by the field programmable logic device for transmission over the communication network via the network port.

17. The apparatus according to claim 10, wherein the field programmable logic device comprises a field programmable gate array (FPGA).

18. The apparatus according to claim 10, wherein the network node comprises an identification (ID) component holding an identification value and coupled to be read by the field programmable logic device, so that when the field programmable logic device is programmed by the program code, the network node conveys the identification value over the network to the code server.

19. The apparatus according to claim 18, wherein the program code comprises start-up program code and operational program code, wherein code server is adapted to initially transmit the start-up program code to the network node, causing the network node to convey the identification value over the network to the code server, and wherein the code server is further adapted, upon receiving the identification value, to select the operational program code to transmit to the network node responsively to the identification value.

20. A method for network communication, comprising:
coupling a node, which comprises a programmable processor, to receive signals from a communication network;
processing the signals at the node in accordance with a predetermined physical layer protocol so as to generate a digital data output;
transmitting the signals on the network in accordance with the physical layer protocol during a programming phase of the network so as to convey program code to the node;
coupling the digital data output to a configuration port of the programmable processor, so as to program the processor using the transmitted program code;
following conclusion of the programming phase, transmitting the signals on the network in accordance the physical layer protocol and with a predetermined data link layer protocol so as to convey communication data over the network to the node; and
coupling the digital data output to a data input port of the programmable processor, so that following the conclusion of the programming phase, the processor processes the communication data, responsively to the program code, in accordance with the data link layer protocol.

21. The method according to claim 20, wherein the node comprises substantially no non-volatile memory for holding the program code.

22. The method according to claim 20, wherein coupling the digital data output to the configuration port comprises connecting the configuration port and the data input port in parallel to receive the digital data output.

23. The method according to claim 22, wherein connecting the configuration port and the data input port in parallel comprises connecting the configuration port and the data input port substantially without other logic components intervening between the ports.

24. The method according to claim 20, wherein the physical layer protocol and data link layer protocol comprise Ethernet protocols.

25. The method according to claim 24, wherein processing the signals comprises generating the digital data output in accordance with an Ethernet media independent interface (MII).

26. The method according to claim 20, wherein transmitting the signals during the programming phase comprises framing the program code in data frames in accordance with the physical layer protocol so as to cause a physical layer interface (PHY) device at the node to generate the digital data output in a format suitable for programming the programmable processor.

27. The method according to claim 26, wherein framing the program code comprises incorporating in the data frames, together with the program code, a sequence of clock bits, so as to cause the PHY device to generate a clock input to the programmable processor for clocking the program code into the configuration port.

28. The method according to claim 20, wherein the program code further causes the programmable processor to generate data frames in accordance with the data link protocol for transmission over the communication network.

29. The method according to claim 20, wherein the programmable processor comprises a field programmable gate array (FPGA).

30. The method according to claim 20, wherein the node comprises an identification (ID) component holding an identification value and coupled to be read by the programmable processor, and wherein transmitting the signals during the programming phase comprises:
initially transmitting start-up program code to the network node, causing the programmable processor to convey the identification value over the network to the code server;
receiving the identification value from the node; and
selecting operational program code to transmit to the node, responsively to the identification value, so as to cause the processor to processes the communication data, responsively to the operational program code, in accordance with the data link layer protocol.
